(19) United States
(12) Patent Application Publication
(10) Pub. No.: US 2006/0152299 A1
(43) Pub. Date: Jul. 13, 2006

(54) Printed circuit board for connection with an external connector

(75) Inventors: Cheng-Tao Lee, Taipei (TW); Fu-Tsun Sun, Taipei (TW); Chia-Ming Lee, Taipei (TW); Yi-De Chen, Taipei (TW)

Correspondence Address: REED SMITH LLP, Suite 1400, 3110 Fairview Park Drive, Falls Church, VA, 22042, US

(73) Assignee: Via Technologies, Inc.

(21) Appl. No.: 11/166,098

(22) Filed: Jun. 27, 2005

(30) Foreign Application Priority Data
Jan. 12, 2005 (TW) 094100830

(51) Int. Cl. H01P 5/02

(52) U.S. Cl. 333/33

(57) ABSTRACT

A multi-layered printed circuit board (PCB) for connection with an external connector. The external connector has a signal pin and an outer conductor. The printed circuit board includes a first conductive reference plane, a signal trace, a second conductive reference plane, a characteristic impedance member, and a third conductive reference plane. The characteristic impedance member is provided for connecting the signal trace and the signal pin. The third conductive reference plane is provided for electrical connection with the outer conductor. There are vertical separations inserted between the first conductive reference plane, the second conductive reference plane, and the third conductive reference plane within the printed circuit.

### CROSS REFERENCE TO RELATED APPLICATIONS

This application claims the right of priority based on Taiwan Patent Application No. 094100830 entitled “Printed Circuit Board for Connection with an External Connector”, filed on Jan. 12, 2005, which is incorporated herein by reference and assigned to the assignee herein.

### FIELD OF INVENTION

The present invention relates generally to the printed circuit boards. More particularly, the present invention relates to a multi-layered printed circuit board for connection with an external connector.

### BACKGROUND OF THE INVENTION

Multi-layered printed circuit boards (PCB) have become increasingly thinner to meet the demand of consumers for smaller and more compact electronic products. One way is to make thinner PCBs by reducing the thickness of the insulation layers between the conductive planes. However, reduced thickness of the insulation layers can affect the characteristic impedance of the signal traces on the PCBs. The characteristic impedance of a signal trace, Z, is primarily determined by [(D·η)/S], in which D is the separation distance between the signal trace and the nearest conductive plane, η is a constant, and S is the width of the signal trace. Accordingly, the characteristic impedance of the signal trace is proportional to D. In addition, the characteristic impedance decreases by increasing S.

FIG. 1A and FIG. 1B illustrate a PCB 100 according to the prior art. In FIG. 1A, the PCB 100 includes a signal trace 102, a first conductive reference plane 104, an insulating layer 106, and a second conductive reference plane 108. The insulating layer 106 provides insulation between the signal trace 102 and the first conductive reference plane 104. For the signal trace 102, the first conductive reference plane 104 is the nearest conductive plane, such that the signal trace 102 has a trace characteristic impedance relative to the first conductive reference plane 104. As described above, the trace characteristic impedance is determined by the width of the signal trace 102 and the separation distance between the signal trace 102 and the first conductive reference plane 104. For example, as the width of the signal trace is 8.5 mil and the separation distance between the signal trace 102 and the first conductive reference plane 104 is 4.3 mil and the dielectric constant ε ᵣ is 4.3, the trace characteristic impedance is approximately 50 Ohm.

The PCB 100 provides for connection with an external connector which has a signal pin 150 and an outer conductor 152. Originally, the signal pin 150 has a signal characteristic impedance relative to the outer conductor 152. Though, as shown in FIG. 1B, as the signal pin 150 is connected to the signal trace 102 and the outer conductor 152 is connected to the second conductive reference plane 108, the signal characteristic impedance is determined by the first conductive plane 104, rather than by the outer conductor 152 nor the second conductive reference plane 108. Typically, the width of the signal pin 150 is wider than the width of the signal trace 102. For example, as the width of the signal pin 150 is 31 mil and the separation distance between the signal pin 150 and the first conductive reference plane 104 is 4.3 mil, the signal characteristic impedance is 20 Ohm. Thus, when a RF signal is transmitted from the signal pin 150 to the signal trace 102, it will encounter an obvious characteristic impedance mismatch, return loss, and power loss.

### SUMMARY OF THE INVENTION

The present invention achieves technical advantages as a printed circuit board (PCB) for connection with an external connector transmitting high frequency RF or analog signals. As the external connector is mounted on the PCB, an characteristic impedance member relieves the characteristic impedance mismatch effect between the external connector and the signal trace by, for instance, utilizing the suitable separation distance between the characteristic impedance member and the nearest conductive plane.

Another advantage of the present invention is that the embodiment of the present invention can be implemented by using a conventional multi-layered PCB. Rather than by changing the thickness of each insulation layer of the PCB between the conductive planes, the characteristic impedance member can be obtained via patterns of the conductive planes.

In one embodiment, disclosed is a multi-layered PCB for connection with an external connector. The external connector has a signal pin and an outer conductor. The printed circuit board includes a first conductive reference plane, a signal trace, a second conductive reference plane, a characteristic impedance member, and a third conductive reference plane. The signal trace has a first characteristic impedance relative to the first conductive reference plane. The characteristic impedance member is provided for connecting the signal trace and the signal pin. The characteristic impedance member has a second characteristic impedance relative to the second conductive reference plane. The third conductive reference plane is provided for electrical connection with the outer conductor. The first conductive reference plane, the second conductive reference plane, and the third conductive reference plane are positioned vertically and separately within the printed circuit board.

Also disclosed is an electronic device for processing RF signals. The electronic device includes the PCB for connection with an RF connector having a signal pin and an outer conductor. The PCB includes a first conductive reference plane, a microstrip, a second conductive reference plane, a pad, and a third conductive reference plane. The width of the microstrip is narrower than the width of the signal pin. The microstrip has a first characteristic impedance relative to the first conductive reference plane. The pad is provided for connecting the microstrip and the signal pin. The pad has a second characteristic impedance relative to the second conductive reference plane. The third conductive reference plane is provided for electrical connection with the outer conductor.

Furthermore, one embodiment of the present invention disclosed a PCB for testing an electronic component mounted. The PCB is provided for connecting to an external connector to transmit a testing signal. The external connector has a signal pin and an outer conductor. The PCB includes a first conductive reference plane, a microstrip for connection with the electronic component to transmit the testing signal from/to the electronic component, a second conductive reference plane, a metal pad, and a third conductive reference plane. The microstrip has a first characteristic impedance relative to the first conductive reference plane. The pad is provided for connecting the microstrip and the signal pin. The pad has a second characteristic impedance relative to the second conductive reference plane. The third conductive reference plane is provided for electrical connection with the outer conductor. The signal pin has a signal characteristic impedance relative to the outer conductor, and the first characteristic impedance is substantially equal to the signal characteristic impedance.

The foregoing and other features of the invention will be apparent from the following more particular description of embodiment of the invention.

### BRIEF DESCRIPTION OF THE DRAWINGS

The present invention is illustrated by way of example and not intended to be limited by the figures of the accompanying drawing, in which like notations indicate similar elements.

FIG. 1A is an illustration of a perspective view of the PCB 100 according to the prior art;

FIG. 1B is an illustration of a cross-sectional view of the PCB 100 according to the prior art;

FIG. 2A is an illustration of a cross-sectional view of the PCB 200 according to an embodiment of the present invention;

FIG. 2B is an illustration of a top view of the PCB 200 according to an embodiment of the present invention;

FIG. 2C is an illustration of a cross-sectional view of the PCB 200 according to another embodiment of the present invention;

FIG. 3 is an illustration of a cross-sectional view of the PCB 300 according to an embodiment of the present invention;

FIG. 4 is an illustration of the electronic device 400 according to an embodiment of the present invention; and

FIG. 5 is an illustration of a top view of the PCB 500 according to an embodiment of the present invention.

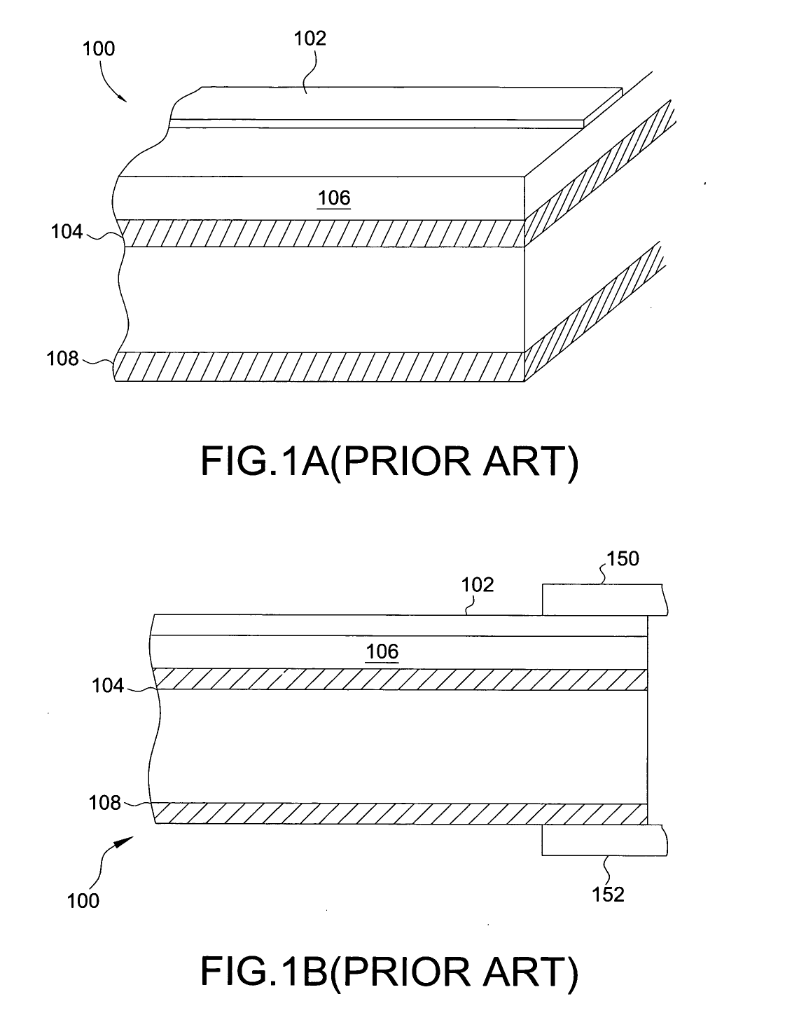

### DETAILED DESCRIPTION

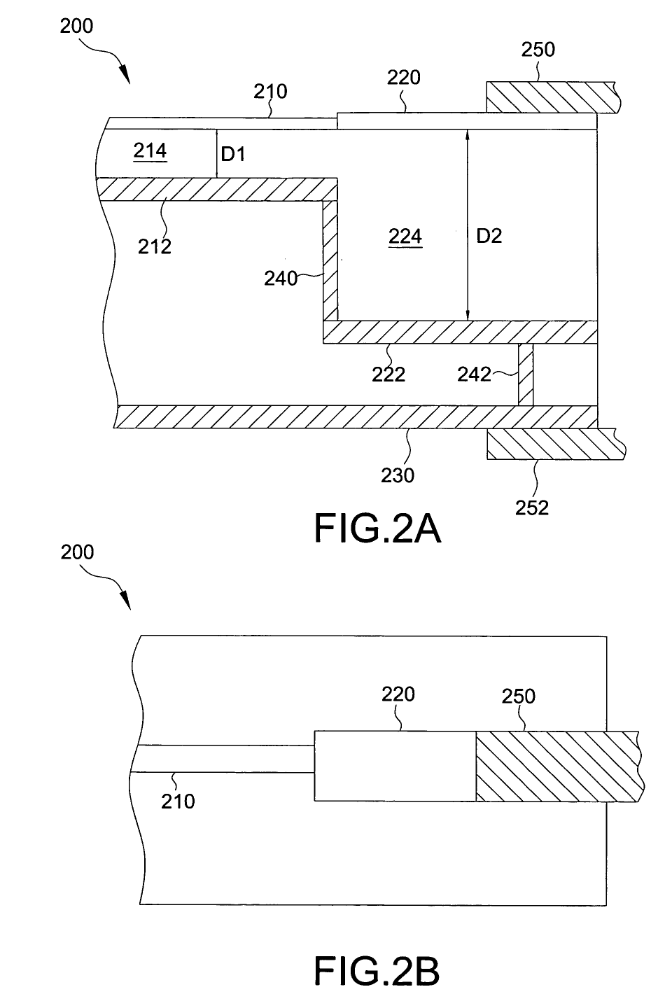

FIGS. 2A-2C illustrate a printed circuit board (PCB) 200 according to one embodiment of the present invention. The PCB 200 can be implemented by polymer, plastic, or resin and is provided for connection with an external connector having a signal pin 250 and an outer conductor 252. The signal pin 250 has a signal characteristic impedance relative to the outer conductor 252. In general, the spacing or separation distance between the signal pin 250 and the outer conductor 252 is predetermined to maintain a predetermined signal characteristic impedance. The external connector used herein is, but not limited to be, a Bayonet Nut Connector (BNC), an “F” connector, or other RF connectors. Preferably, the external connector is a Sub Miniature Series A (SMA) connector operating at RF frequency levels.

The PCB 200 includes a signal trace 210, a first conductive reference plane 212, a characteristic impedance member 220, a second conductive reference plane 222, and a third conductive reference plane 230. The signal trace 210, having a first characteristic impedance relative to the first conductive reference plane 212, can be used to connect electronic components (not shown) mounted on the PCB 200. For example, the first characteristic impedance is about 50 Ohm for typical electronic signal transmission. The signal trace 210 is a minimum size trace, such as a microstrip. The width of the signal trace 210 is narrower than the width of the signal pin 250, as shown in FIG. 2B. The characteristic impedance member 220 connects the signal trace 210 and the signal pin 250. The signal trace 210 and the characteristic impedance member 220 can be implemented by a low resistance metal, such as copper. The characteristic impedance member 220 has a second characteristic impedance relative to the second conductive reference plane 222. Typically, in order to provide effective contact with the signal pin 250, the width of the characteristic impedance member 220 is not narrower than the width of the signal pin 250, as shown in top view of FIG. 2B. For example, the characteristic impedance member 220 is a copper pad 220 as wide as the signal pin 250.

The third conductive reference plane 230 electrically connects to the outer conductor 252. The first conductive reference plane 212, the second conductive reference plane 222, and the third conductive reference plane 230 are positioned vertically and separately within the PCB 200.

In FIG. 2A, both the signal trace 210 and the characteristic impedance member 220 are formed on one side of the PCB 200. In other embodiment, the signal trace 210 and the characteristic impedance member 220 are formed within the PCB 200. The signal trace 210 and the first conductive reference plane 212 are separated by a first insulating layer 214, and the signal trace 210 is formed right above the first conductive reference plane 212. Likewise, the characteristic impedance member 220 and the second conductive reference plane 222 are separated by a second insulating layer 224, and the characteristic impedance member 220 is formed right above the second conductive reference plane 222. Layers 214 and 224 are typically formed of non-conductive material, such as a standard FR4 fiberglass.

The separation distance D2 between the characteristic impedance member 220 and the second conductive reference plane 222 is different from the separation distance D1 between the signal trace 210 and the first conductive reference plane 212. It should be noted that the overall second characteristic impedance is a function of D2 and the width of the characteristic impedance member 220. In one embodiment, the overall second characteristic impedance is substantially equal to the first characteristic impedance and the signal characteristic impedance, approximately 50 Ohm for typical electronic signal transmission. Thus the PCB 200 provides much smooth characteristic impedance transformation for the signals transmission between the signal trace 210 and the signal pin 250. Also, it should be noted that the any selection for D2 and the width of the characteristic impedance member 220 is included in the scope of the present invention. Those skilled in that art should know how to select the suitable D2 and the width of the characteristic impedance member 220 to minimize characteristic impedance mismatch, return loss, and power loss.

In one embodiment, the first conductive reference plane 212, the second conductive reference plane 222, and the third conductive reference plane 230 are grounded. In another embodiment, the first conductive reference plane 212, the second conductive reference plane 222, and the third conductive reference plane 230 are power planes providing a same voltage.

Referring again to FIG. 2A, the first conductive reference plane 212, the second conductive reference plane 222, and the third conductive reference plane 230 are electrically connected. The PCB 200 further includes a first via hole 240 passing through the PCB 200 to electrically connect the first conductive reference plane 212 and the second conductive reference plane 222, and a second via hole 242 passing through the PCB 200 to electrically connect the second conductive reference plane 222 and the third conductive reference plane 230. Preferably, the first via hole 240 is placed right below the joint of the signal trace 210 and the characteristic impedance member 220, and the second via hole 242 is placed right below where the signal pin 250 contacts the characteristic impedance member 220. It should be noted that the implementation of a plurality of the first via holes 240 to electrically connect plane 212 to the plane 222 or the implementation of a plurality of the second via holes 242 to connect plane 222 to the plane 230 are included in the present invention. In addition to via holes, other equivalent approaches to electrically connect plane 212 to the plane 222 or approaches to connect plane 222 to the plane 230 should be known to those skilled in the art and thus are omitted in the description.

Referring to FIG. 2C, the PCB 200 further includes a conductive reference plane 262, which is placed within the PCB 200 as horizontally as the second conductive reference plane 222. In one embodiment, the conductive reference plane 262 and the second conductive reference plane 222 are electrically connected. In another embodiment, the conductive reference plane 262 and the second conductive reference plane 222 are electrically insulated, and the conductive reference plane 262 is a ground plane or a power plane that can be used to provide potentials to electronic components mounted on the PCB 200.

Those skilled in the art should appreciate that the PCB 200 can be implemented in a conventional multi-layered PCB structure. For example, D1 is 4.3 mil, D2 is 20.3 mil or 36.3 mil, and the separation distance between the signal pin 250 and the outer conductor 252 is 56.6 mil. Besides, the width of the signal trace 210 is 8.5 mil for the first characteristic impedance of approximately 50 Ohm.

The width of the characteristic impedance member 220 is 38 mil as D2 is 20.3 mil, or 70 mil as D2 is 36.3 mil, both for the second characteristic impedance of approximately 50 Ohm.

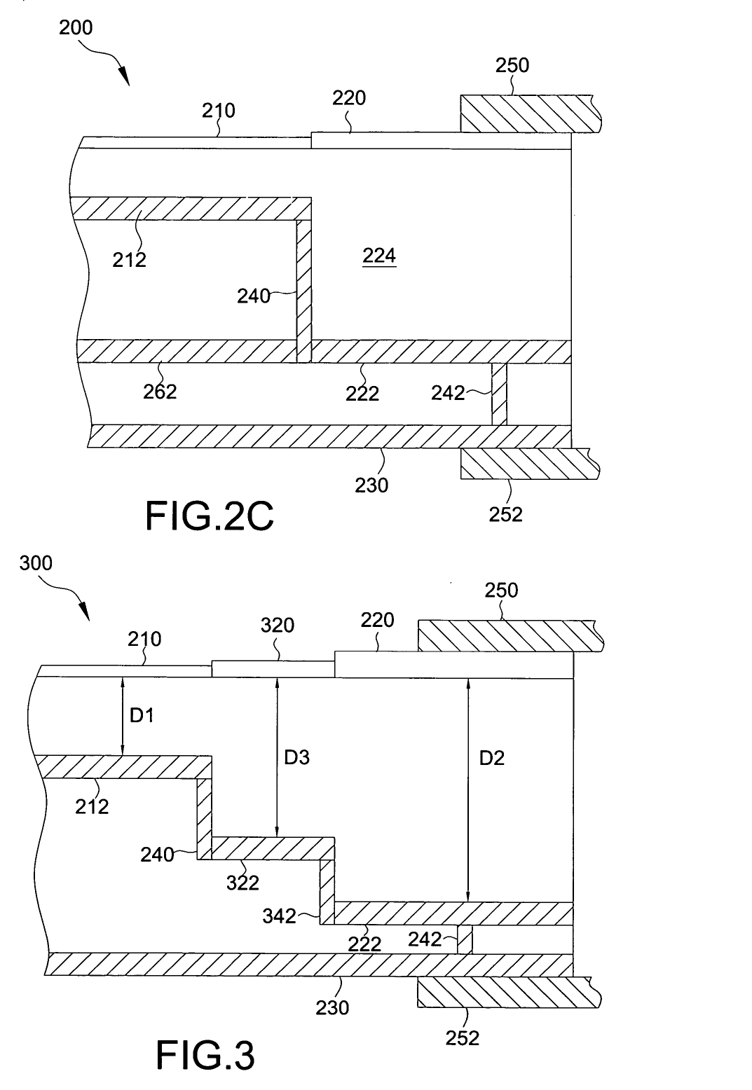

FIG. 3 illustrates a PCB 300 according to another embodiment of the present invention. In comparison with the PCB 200 of FIG. 2A, PCB 300 further includes a second characteristic impedance member 320 and a fourth conductive reference plane 322. The second characteristic impedance member 320 connects the signal trace 210 and the characteristic impedance member 220. And it should be noted that for the purpose of illustration only, the thickness of the second characteristic impedance member 320 is different than the thickness of the signal trace 210 and the thickness of characteristic impedance member 220.

The second characteristic impedance member 320 has a third characteristic impedance relative to the fourth conductive reference plane 322. It should be noted that the overall third characteristic impedance is a function of D3 and the width of the second characteristic impedance member 320. Also, it should be noted that the any selection for D3 and the width of the second characteristic impedance member 320 is included in the scope of the present invention. Those skilled in that art should know how to select the suitable D3 and the width of the characteristic impedance member 320 to minimize characteristic impedance mismatch, return loss, and power loss. In comparison with PCB 200, PCB 300 can provide smoother characteristic impedance transformation for the signals transmission between the signal trace 210 and the signal pin 250. In FIG. 3, the first via hole 240 electrically connects the first conductive reference plane 212 and the forth conductive reference plane 322; the PCB 300 further includes a third via hole 342 passing through the PCB 300 to electrically connect the fourth conductive reference plane 322 and the second conductive reference plane 222. Preferably, the third via hole 342 is placed right below the joint of the characteristic impedance member 220 and the second characteristic impedance member 320.

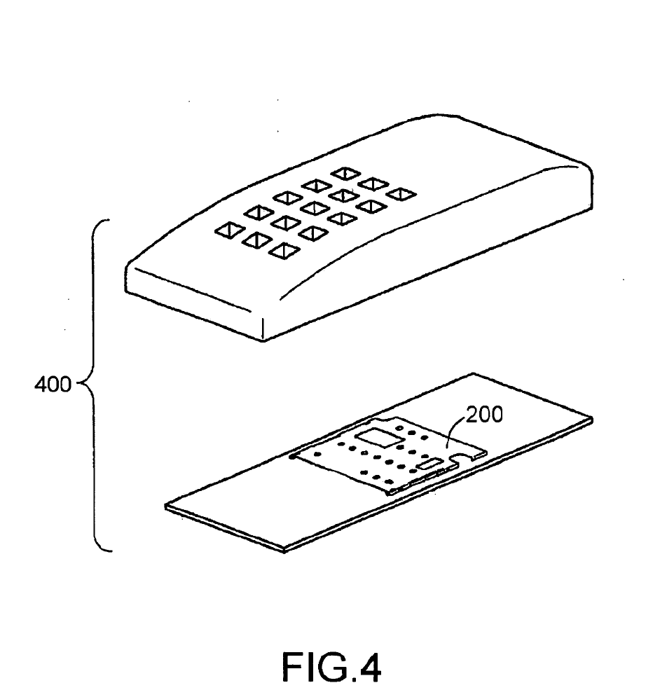

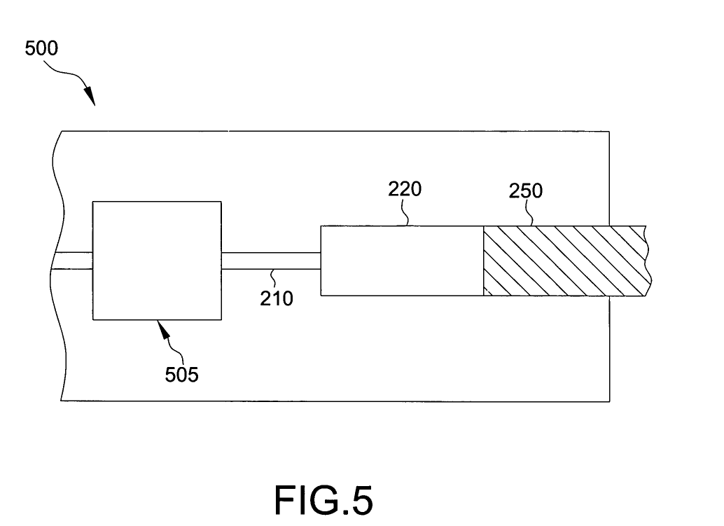

As will be appreciated by one of ordinary skill in the art, the present invention can be embodied in an electronic device 400, as shown in FIG. 4, including a PCB 200 for processing RF signals inputted from an external connector (shown as the signal pin 250 and the external conductor 252). The electronic device 400 can be a mobile phone, a wireless linked PDA, or the like. Besides, the present invention can be embodied as a PCB 500 for testing an electronic component 505 mounted thereon because the testing signal input at the signal pin 250 does not degrade by the Characteristic impedance transformation provided by the present invention.

While this invention has been described with reference to the illustrative embodiments, these descriptions should not be construed in a limiting sense. Various modifications of the illustrative embodiments, as well as other embodiments of the invention, will be apparent upon reference to these descriptions. It is therefore contemplated that the appended claims will cover any such modifications or embodiments as falling within the true scope of the invention and its legal equivalents.

1. A printed circuit board (PCB) for connection with an external connector, said external connector having a signal pin and an outer conductor, said printed circuit board comprising:
a first conductive reference plane;
a signal trace having a first characteristic impedance relative to said first conductive reference plane;
a second conductive reference plane;
a characteristic impedance member for connecting said signal trace and said signal pin, said characteristic impedance member having a second characteristic impedance relative to said second conductive reference plane; and
a third conductive reference plane for electrical connection with said outer conductor;
wherein said first conductive reference plane, said second conductive reference plane, and said third conductive reference plane are electrically connected and horizontally distributed, and there are vertical separations inserted between said first conductive reference plane, said second conductive reference plane, and said third conductive reference plane within said printed circuit.

2. The printed circuit board of claim 1, wherein a width of said signal trace is narrower than a width of said signal pin.

3. The printed circuit board of claim 1, further comprising a first insulating layer disposed between said signal trace and said first conductive reference plane, and a second insulating layer disposed between said characteristic impedance member and said second conductive reference plane, said second insulating layer being thicker than said first insulating layer.

4. The printed circuit board of claim 1, wherein said first conductive reference plane, said second conductive reference plane, and said third conductive reference plane are grounded.

5. The printed circuit board of claim 1, wherein said first conductive reference plane, said second conductive reference plane, and said third conductive reference plane are power planes providing a same voltage.

6. The printed circuit board of claim 1, further comprising a first via hole passing through said printed circuit board to electrically connect said first conductive reference plane and said second conductive reference plane, and a second via hole passing through said printed circuit board to electrically connect said second conductive reference plane and said third conductive reference plane.

7. The printed circuit board of claim 1, wherein said signal trace is a microstrip.

8. The printed circuit board of claim 1, wherein said signal pin has a signal characteristic impedance relative to said outer conductor, and said first characteristic impedance is substantially equal to said signal characteristic impedance.

9. The printed circuit board of claim 1, wherein said signal pin has a signal characteristic impedance relative to said outer conductor, and said second characteristic impedance is substantially equal to said signal characteristic impedance.

10. An electronic device for processing RF signals, said electronic device comprising a printed circuit board (PCB) for connection with an RF connector, said RF connector having a signal pin and an outer conductor, said printed circuit board comprising:
a first conductive reference plane;
a microstrip, a width of said microstrip is being narrower than a width of said signal pin, said microstrip having a first characteristic impedance relative to said first conductive reference plane;
a second conductive reference plane;
a pad for connecting said microstrip and said signal pin, said pad having a second characteristic impedance relative to said second conductive reference plane; and
a third conductive reference plane for connection with said outer conductor;
wherein said first conductive reference plane, said second conductive reference plane, and said third conductive reference plane are electrically connected and horizontally distributed, and there are vertical separations inserted between said first conductive reference plane, said second conductive reference plane, and said third conductive reference plane within said printed circuit.

11. The electronic device of claim 10, further comprising a first insulating layer disposed between said microstrip and said first conductive reference plane, and a second insulating layer disposed between said pad and said second conductive reference plane, said second insulating layer being thicker than said first insulating layer.

12. The electronic device of claim 10, wherein said first conductive reference plane, said second conductive reference plane, and said third conductive reference plane are grounded.

13. The electronic device of claim 10, wherein said first conductive reference plane, said second conductive reference plane, and said third conductive reference plane are power planes providing a same voltage.

14. The electronic device of claim 10, further comprising a first via hole passing through said printed circuit board to electrically connect said first conductive reference plane and said second conductive reference plane, and a second via hole passing through said printed circuit board to electrically connect said second conductive reference plane and said third conductive reference plane.

15. The electronic device of claim 10, wherein said signal pin has a signal characteristic impedance relative to said outer conductor, and said first characteristic impedance is substantially equal to said signal characteristic impedance.

16. The electronic device of claim 15, wherein said second characteristic impedance is substantially equal to said signal characteristic impedance.

17. A printed circuit board (PCB) for testing an electronic component mounted on said printed circuit board, said printed circuit board connecting to an external connector to transmit a testing signal, said external connector having a signal pin and an outer conductor, said printed circuit board comprising:
a first conductive reference;
a microstrip for connection with said electronic component to transmit said testing signal from/to said electronic component, said microstrip having a first characteristic impedance relative to said first conductive reference plane;
a second conductive reference plane;
a pad for connecting said microstrip and said signal pin, said pad having a second characteristic impedance relative to said second conductive reference plane; and
a third conductive reference plane for connection with said outer conductor;
wherein said first conductive reference plane, said second conductive reference plane, and said third conductive reference plane are electrically connected and horizontally distributed, and there are vertical separations inserted between said first conductive reference plane, said second conductive reference plane, and said third conductive reference plane within said printed circuit; and
wherein said signal pin has a signal characteristic impedance relative to said outer conductor, and said first characteristic impedance is substantially equal to said signal characteristic impedance.

18. The printed circuit board of claim 17, wherein a width of said signal trace is narrower than a width of said signal pin.

19. The printed circuit board of claim 17, wherein said first conductive reference plane, said second conductive reference plane, and said third conductive reference plane are grounded.

20. The printed circuit board of claim 17, wherein said first characteristic impedance, said second characteristic impedance, and said signal characteristic impedance are substantially equal.
